(19) United States
(12) Patent Application Publication
(10) Pub. No.: US 2015/0096397 A1
(43) Pub. Date: Apr. 9, 2015

(54) BALL SCREW CAPABLE OF SENSING TORQUE IN REAL TIME

(71) Applicant: National Chung Cheng University, Chia-Yi County (TW)

(72) Inventors: Yeau-Ren JENG, Tainan City (TW); Yu-Xian HUANG, Tainan City (TW)

(73) Assignee: National Chung Cheng University, Chia-Yi County (TW)

(21) Appl. No.: 14/047,291

(22) Filed: Oct. 7, 2013

(51) Int. Cl. F16H 25/20; G01L 3/14; F16H 57/04; F16H 25/22

(52) U.S. Cl. CPC F16H 25/2021; F16H 25/2214; G01L 3/1464; F16H 57/0497
USPC 74/424.82

(57) ABSTRACT

A ball screw capable of sensing a torque in real time includes a screw rod, a screw nut sleeved onto the screw rod, a plurality of balls mounted between the screw rod and the screw nut, and a torque sensor haying a first fastening portion and a second fastening portion. The first fastening portion is fixed to a working bench and the second fastening portion is fixed to the screw nut, so the torque sensor can sense how much the torque is while the screw out is driving a working bench to move. In light of this structure, monitoring the voltage value outputted by the torque sensor can sense the torque generated while the working screw rod is working.

### BACKGROUND OF THE INVENTION

1. Field of the Invention

The present invention relates generally to a ball screw and more particularly, to a ball screw capable of sensing torque in real time.

2. Description of the Related Art

A ball screw is a common component in precision positioning and keeps rolling to serve as the power transmission interface between the screw rod and the screw nut for much reduction of frictional resistance generated while the screw nut is working. However, in the process of processing a workpiece, different sizes of the workpieces lead to different torque applied to the screw nut. For example, if the workpiece is too heavy, enormous torque will occur while the screw nut is moving; meanwhile, if there is none of any immediate lubrication, the wear and tear will happen between the screw nut and the screw rod to further make the preload gradually disappear, thus reducing the positioning accuracy.

Taiwan Patent No. I407026 disclosed a method diagnostic of preload ineffectiveness of a ball screw and a device based on the method, in which a voiceprint signal generated while the ball screw is working can be filtered by empirical mode decomposition (EMD), then processed by Hilbert-Huang transform (HHT) to generate Hilbert-Huang spectrum (HHS), next processed by multi-scale entropy extraction to generate multi-scale entropy complexity mode, and after the raw multi-scale entropy complexity mode and the current multi-scale entropy complexity mode are compared, whether a preload of the ball screw disappears or not can be effectively diagnosed for the user to monitor the ball screw. However, in the process of measurement based on this method, the measuring accuracy may be adversely affected easily subject to other environmental factors, such as vibration, noise, or frequency. In other words, this method fails to provide accurate measuring outcome for the preload of the ball screw.

### SUMMARY OF THE INVENTION

The primary objective of the present invention is to provide a ball screw, which can directly sense a torque applied to the working screw nut.

The foregoing objective of the present invention is attained by the ball screw formed of a screw rod, a screw nut, and a plurality of balls. The screw rod includes an external thread. The screw nut is sleeved onto the screw rod and includes an internal circulatory passage and an internal thread. A spiral passage is formed between the internal thread and the external thread and linked with the internal circulatory passage to define a load path with the internal circulatory passage. The balls are rollingly mounted within the load path. The torque sensor includes a first fastening portion and a second fastening portion opposite to the first fastening portion. The first fastening portion is fixed to a working bench and the second fastening portion is fixed to the screw nut, so the torque sensor can sense how much the torque is while the screw nut is working and meanwhile indirectly indicate whether the preload is changed or not in the process of operation of the ball screw.

### BRIEF DESCRIPTION OF THE DRAWINGS

FIG. 1 is a perspective view of the ball screw in accordance with a preferred embodiment of the present invention.

FIG. 2 is a lateral view of the ball screw in accordance with the preferred embodiment of the present invention.

FIG. 3 is a sectional view of a part of the ball screw in accordance with the preferred embodiment of the present invention.

FIG. 4 is a block diagram of the ball screw in accordance with the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

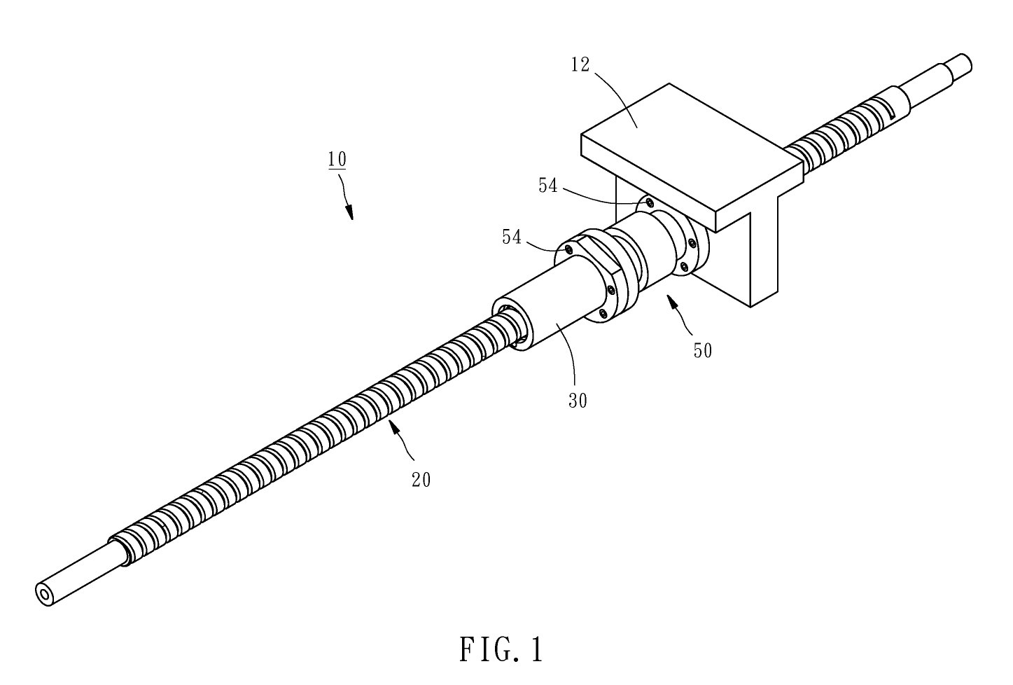

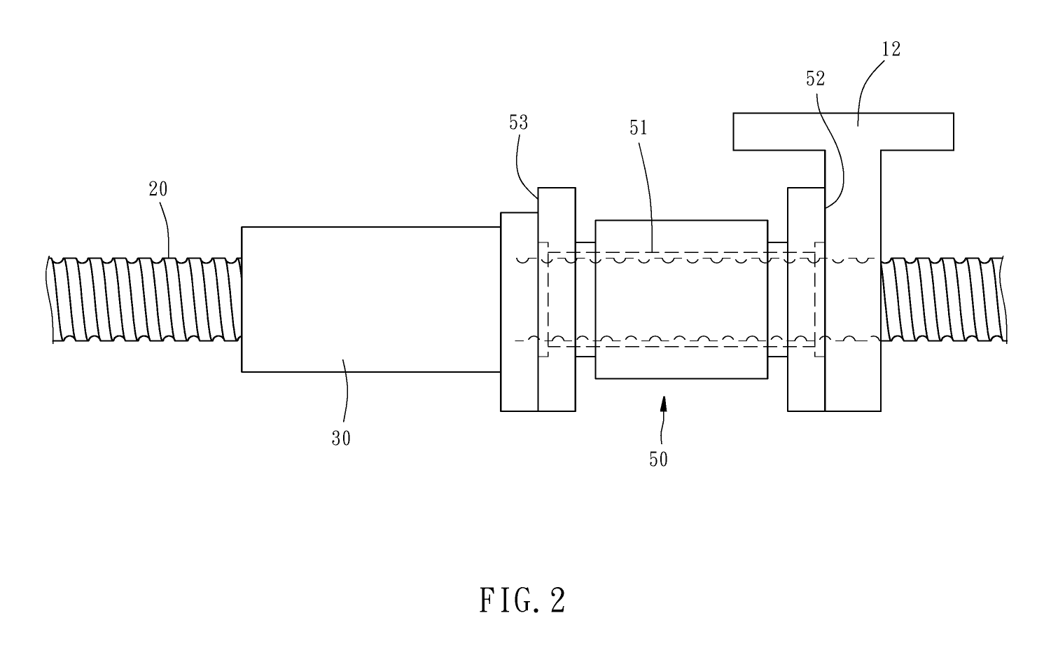

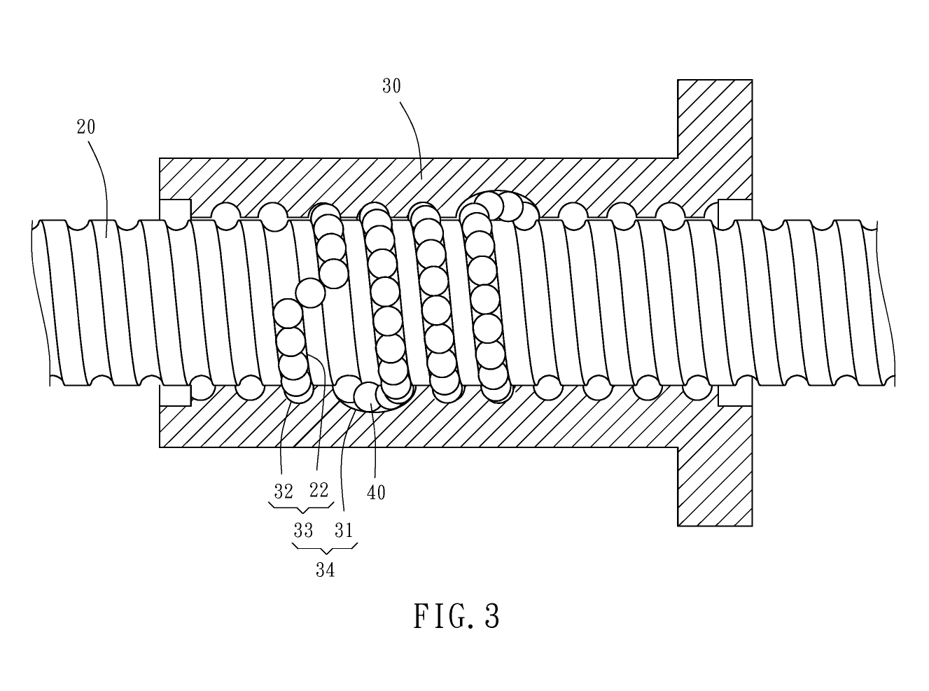

Referring to FIGS. 1 and 2, the ball screw 10 constructed according to a preferred embodiment of the present invention is adapted for driving a working bench 12 to move. Referring FIGS. 2 and 3, the ball screw 10 is formed of a screw rod 20, a screw nut 30, a plurality of balls 40, and a torque sensor 50. The detailed descriptions and operations of these elements as well as their interrelations are recited in the respective paragraphs as follows.

The screw rod 20 runs through the working bench 12 and includes an extern al thread 22.

The screw nut 30 is sleeved onto the screw rod 20 and includes an internal circulatory passage 31 and an internal thread 32. As shown in FIG. 3, a spiral passage 33 is formed between the internal thread 32 and the external thread 22 and linked with the internal circulatory passage 31, so in this way, a load path 34 is formed between the spiral passage 33 and the load path 34.

The balls 40 are mounted within the load path 34 for reducing frictional resistance generated while the screw nut 30 is working relative to the screw rod 20.

The torque sensor 50 includes a through hole 51 for the screw rod 20 to be inserted through. The through hole 51 has a diameter that is larger than an external diameter of the screw rod 20, as shown in FIG. 2, to prevent the screw rod 20 from substantial contact with the torque sensor 50 after the screw rod 20 is inserted through the through hole 51. The torque sensor 50 includes a first fastening portion 52 and a second fastening portion 53 opposite to and parallel to the first fastening portion 52. The first and second fastening portions 52 and 53 are fixed to the working bench 12 and the screw nut 30 via a plurality of screw bolts 54, respectively, as shown in FIG. 1, to make the torque sensor 50 be located between the working bench 12 and the screw nut 30 after the assembly of the torque sensor is completed. It is worth mentioning that the torque sensor 50 in this preferred embodiment is not limited to this structure. For example, the torque sensor 50 is not sleeved onto the screw rod 20, being a modification falling within the scope of the present invention as long as the torque sensor 50 is fixed between the working bench 12 and the screw nut 30.

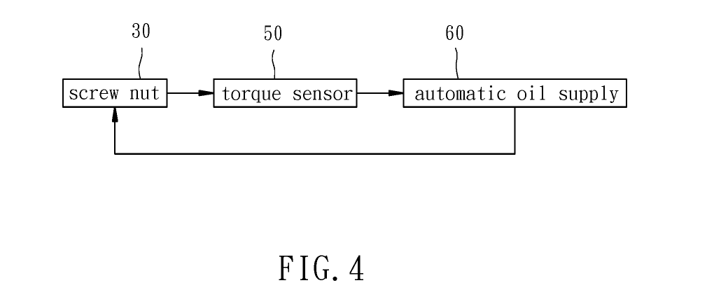

In actual operation, as shown in FIG. 3, the screw nut 30 can move along an axial direction of the screw rod 20 subject to the rotation of the screw rod 20. In the process of the movement of the screw nut 30, the working bench 12 can be moved together via the torque sensor 50. Under the circumstances, the torque applied to the screw nut 30 is variable subject to the size of a workpiece supported by and on the working bench 12. In the meantime, the torque sensor 51 can output a voltage value corresponding to a change of the torque. The outputted voltage can be converted to identify whether the torque is normal in the process of operation of the screw nut 30. In addition, referring to FIG. 4, to enable supplying the screw nut 30 with oil, the torque sensor 50 can be electrically connected with an automatic oil supply 60. The automatic oil supply 60 can identify whether it is necessary to supply the screw nut 30 with oil according to the torque sensed by the torque sensor 50. Once the torque is overgreat, the automatic oil supply 60 will supply the screw nut 30 with oil to prolong the service life of the ball screw 10.

In conclusion, the ball screw 10 of the present invention can sense the torque applied to the working screw rod 11 in real time. In this way, the user can make sure that the screw rod 30 keeps the normal preload by means of monitoring the voltage value outputted by the torque sensor 50, so the whole structure of the ball screw 10 can have preferable rigidity, positioning accuracy, and positioning stability.

What is claimed is:

1. A ball screw for driving a working bench to move, comprising:
a screw rod having an external thread;
a screw nut sleeved onto the screw rod and having an internal circulatory passage and an internal thread, a spiral passage being formed between the internal thread of the screw nut and the external thread of the screw rod and linked with the internal circulatory passage to define a load path with the internal circulatory passage;
a plurality of halls rollingly mounted within the load path; and
a torque sensor having a first fastening portion and a second fastening portion opposite to the first fastening portion, the first and second fastening portions being fixed to the working bench and the screw nut, respectively.

2. The ball screw as defined in claim 1, wherein the first and second fastening portions are parallel to each other.

3. The ball screw as defined in claim 1, wherein the torque sensor comprises a through hole for the screw rod to be inserted through, the through hole having a diameter larger than that of the screw rod.

4. The ball screw as defined in claim 1, wherein the torque sensor is electrically connected with an automatic oil supply, which supplies the screw nut with oil according to a torque sensed by the torque sensor.
